(19) United States
(12) Patent Application Publication
(10) Pub. No.: US 2020/0288766 A1
(43) Pub. Date: Sep. 17, 2020

(54) FOOD COATING COMPOSITIONS AND METHODS OF MAKING FOOD COATING COMPOSITIONS

(71) Applicant: The Edlong Corporation, Elk Grove Village, IL (US)

(72) Inventor: Stephen M. Haverkos, Willowbrook, IL (US)

(21) Appl. No.: 16/351,817

(22) Filed: Mar. 13, 2019

(51) Int. Cl. A23P 20/10; A23P 20/15; A23L 27/00; A23L 27/20

(52) U.S. Cl. CPC A23P 20/11; A23P 20/15; A23L 5/11; A23L 27/2028; A23L 27/70

(57) ABSTRACT

Food coating compositions and their methods of making are disclosed herein. In one embodiment, the method includes mixing a porous coating composition with at least one flavor composition, wherein at least a portion of the at least one flavor composition is absorbed into pores of the porous coating composition; heating an oil feedstock to a temperature greater than the melting point of the oil feedstock to form a liquid oil; mixing the liquid oil with the at least one flavor composition prior to, contemporaneous with, or after the at least one flavor composition is mixed with the porous coating composition to provide an oil-flavor-porous coating mixture; and cooling the oil-flavor-porous coating mixture to 25° C. or less to form a food coating composition, wherein the liquid oil solidifies as an exterior coating for the porous coating composition and the flavor composition absorbed within the pores of the porous coating composition.

### FIELD

The following disclosure relates to a coating or batter composition for food products. More specifically, the following disclosure relates to food coating compositions having a porous coating material configured to absorb and protect flavor components from being prematurely released (e.g., evaporating) before fully cooking and consuming a food product coated with the food coating composition. The disclosure also relates to methods of making such food coating or batter compositions.

### BACKGROUND

Batter and bread coated fried foods have a broad appeal. For example, popular batter and bread fried foods include fried chicken, fish, and other meat products as well as a variety of other foods such as vegetables (e.g., potatoes) and even fruits. Batters typically consist primarily of farinaceous materials such as starches and flours. The batters are generally hydrated with water so that they can be applied to the food product such as by dipping, spraying, or other known techniques. Breadings typically consists of wheat flour, corn meal, cracker crumbs, bread crumbs and the like. Breadings are generally applied after some form of batter coating.

In practice, the food product to be fried is coated with a batter or breading or both, and then par-fried or raw breaded or frozen. The product can then be finished cooked such as by deep frying.

In certain examples, flavoring agents or compositions may be added to the batter composition prior to par-frying or fully cooking (e.g., deep frying or microwaving) the food product.

One drawback of adding a flavor composition to a coating is that the flavor composition may be prematurely released or reacted (e.g., evaporated or oxidized) during the pre-cooking or par-cooking acts, prior to the desired time for the release of flavor.

Prior solutions to retaining flavors within a batter or food coating composition have included adding more flavor compositions with an understanding that a portion of the flavor will be lost prematurely. Understandably, such an approach is cost prohibitive and wasteful.

Alternatively, or additionally, flavor compositions may be encapsulated in an effort to protect the flavor from being evaporated or oxidized. Encapsulation techniques have included hydrocolloids such as starches, dextrin, maltodextrin, gum arabic, gelatin, and the like as carriers or encapsulation agents. While encapsulation techniques provide some level of protection during pre-consumption processing of the food coating or batter composition, there remains a need for improved food coatings with flavor compositions that provide for a controlled release of flavor during heating or other phases of pre-consumption preparation.

### SUMMARY

The disclosure provides embodiments for food coating compositions and methods of making such compositions. In one embodiment, a method of making a food coating composition includes providing a porous coating composition, at least one flavor composition, and an oil feedstock having a melting point greater than 20° C.; mixing the porous coating composition with the at least one flavor composition, wherein at least a portion of the at least one flavor composition is absorbed into pores of the porous coating composition; heating the oil feedstock to a temperature greater than the melting point of the oil feedstock to form a liquid oil; mixing the liquid oil with the at least one flavor composition prior to, contemporaneous with, or after the at least one flavor composition is mixed with the porous coating composition to provide an oil-flavor-porous coating mixture; and cooling the oil-flavor-porous coating mixture to 25° C. or less to form a food coating composition, wherein the liquid oil solidifies as an exterior coating for the porous coating composition and the flavor composition absorbed within the pores of the porous coating composition.

In another embodiment, a food coating composition includes 30-80 percent by weight of a porous composition comprising cracker meal, bread crumbs, a textured protein, or a combination thereof; 0.1-30 percent by weight of at least one flavor composition, wherein at least a portion of the flavor composition is absorbed within pores of the porous composition; and 10-50 percent by weight of an oil feedstock having a melting point greater than 20° C., wherein the oil feedstock is an exterior coating of the food coating composition, encapsulating the porous composition and the absorbed flavor composition.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Exemplary embodiments are described herein with reference to the following drawings.

FIG. 1 illustrates an example flowchart for making a food coating composition.

FIG. 2 illustrates an additional example flowchart for making a food coating composition.

FIG. 3 illustrates an example flowchart for preparing a batter composition and coating a food product with the batter composition.

While the disclosed compositions and methods are representative of embodiments in various forms, specific embodiments are illustrated in the drawings (and are hereafter described), with the understanding that the disclosure is intended to be illustrative and is not intended to limit the claim scope to the specific embodiments described and illustrated herein.

### DETAILED DESCRIPTION

As described in further detail below, food coating and batter compositions are provided, as well as their methods of making. The compositions and their methods of making disclosed herein are advantageous over conventional coating compositions for their ability to protect potentially volatile flavor agents or compositions within the food coating material from being prematurely released (e.g., evaporated or flashed off) before fully cooking and/or consuming a food product coated with the food coating composition. In other words, the food coating composition provides for a time-release of the flavor composition within the coating composition. Further, due to the composition characteristics and the method of making (e.g., due to a lower volatility of the flavor compositions being protected within the food coating composition), a lower amount of flavor agent or flavor composition may be used within the overall food coating or batter formulation. This may be advantageous in reducing manufacturing costs, as flavor compositions may be one of the more expensive ingredients within the food coating or batter composition. Furthermore, to the extent the food coating composition is coated on a food product in frying oil, the food coating composition may be advantageous in reducing the amount of contamination of the frying oil, as less flavor compositions are being released or flashed off in the frying oil (as compared to a coating composition without the sealed-in flavor disclosed herein). This may allow for a reduction in cost, as less frying oil may be required due to lower contamination.

The food coating and batter compositions include a porous coating composition, at least one flavor agent or composition, and an oil feedstock. The at least one flavor composition is configured to be absorbed or embedded within the pores of the porous coating composition. This is advantageous in protecting the flavor composition from prematurely volatizing or evaporating from the food coating or batter composition during the formulation or pre-cooking stages of making the coating or batter composition, coating a food product, or par-cooking the food product. The oil feedstock provides an external coating or shell around the porous coating composition and flavor composition absorbed within the pores of the porous coating composition. This is advantageous in providing a further obstacle for premature volatizing or evaporating of the flavor composition. For example, the oil feedstock may provide an external coating or shell that protects heat from penetrating into the porous coating composition during cooking, therein evaporating the flavor composition. In other words, the oil feedstock external coating may allow for a crust to form during initial stages of cooking a food product with the food coating or batter composition, sealing in the flavor.

Additional compositions may be included within the food coating and batter compositions. The various compositions within the food coating and batter compositions and their methods of making are disclosed in further detail below.

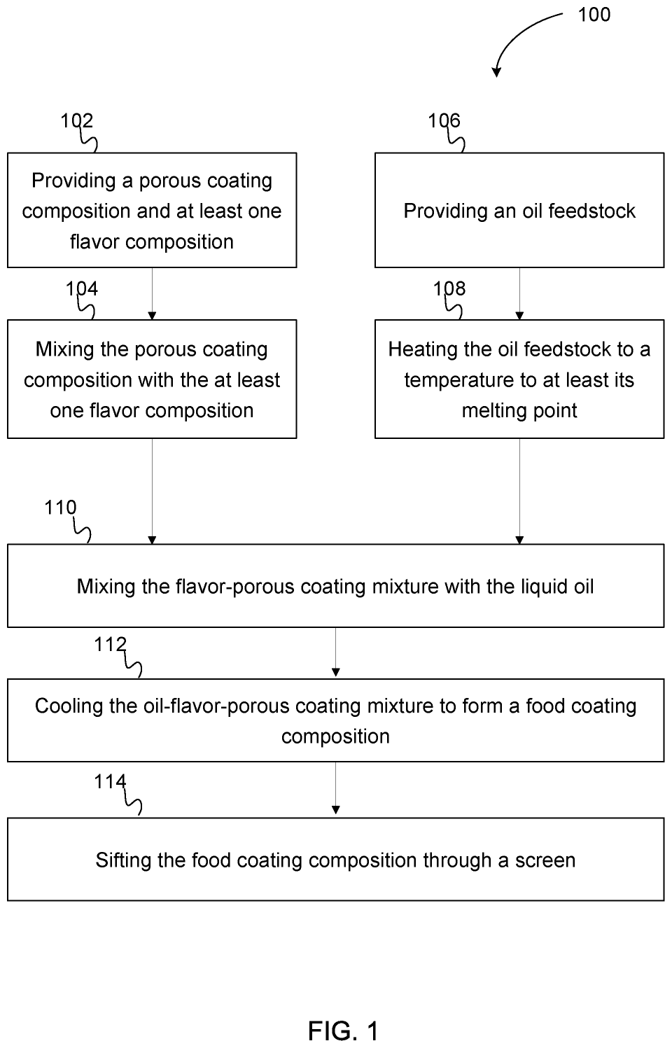

FIG. 1 illustrates an example flowchart 100 for making a food coating composition. Additional, fewer, or different acts may be included within the method of making. In this example, the food coating composition includes a porous coating composition, at least one flavor agent or composition, and an oil feedstock. Examples of these various components are disclosed in greater detail below.

The weight percentages of each component may be varied. As mentioned above, one advantage of this composition and its method of making is a possible reduction in the amount of flavor agents or compositions needed (due to less volatizing during the method of making and cooking the food product).

As such, the food coating composition may include the various amounts of each of the following components: (1) Porous coating composition: 30-80 percent by weight, 40-70 percent by weight, 45-65 percent by weight, or 50-60 percent by weight; (2) Flavor Agents or Compositions: 0.1-30 percent by weight, 1-20 percent by weight, 5-15 percent by weight, or 10-20 percent by weight; and (3) Oil feedstock: 10-50 percent by weight, 20-40 percent by weight, 25-35 percent by weight, or approximately 30 percent by weight oil feedstock.

In act 102, a porous coating composition and at least one flavor composition are provided. The porous coating composition may be any breading or protein composition having a textured or porous surface capable of receiving or absorbing a flavor agent or composition. In certain examples, at least a portion (e.g., all) of the pores or openings within the porous composition are greater than a diameter or widest dimension of each flavor composition such that the flavor compositions are configured to fit into the pores or openings of porous coating composition.

In certain examples, the porous coating composition includes cracker meal, bread crumbs (e.g., United States style bread crumbs or Japanese-Panko style bread crumbs), a textured protein, or a combination thereof. In some examples, the porous coating composition includes cracker meal.

Cracker meal or bread crumbs may be formed from crumbled crackers or dry bread pieces therein providing a textured, porous surface. Textured proteins may be formed through an extraction of a vegetable protein from a vegetable oil (e.g., soy protein extracted from soybean oil). The extracted vegetable proteins may be extruded into various shapes (e.g., chunks, flakes, nuggets, grains, or strips), and then denatured through heating to form a fibrous, porous coating composition.

The at least one flavor agent or composition may be any type of flavor agent or composition used within food coatings. In other words, a flavor composition may be any composition suitable for imparting a flavor to, enhancing the flavor in, or altering the flavor of, a food composition. For example, the at least one flavor agent or composition may be a composition capable of imparting a definite flavor to a tasteless or bland foodstuff, or enhancing a particular flavor of a natural or other material that may be deficient in flavor. Such flavor compositions may be useful for improving the flavor of a meat or fish product, for instance.

The flavor composition may include organic acids including fatty, saturated, unsaturated and amino acids, alcohols, including primary and secondary alcohols, esters, carbonyl compounds including aldehydes and ketones, lactones, cyclic organic materials including benzene derivatives, alicyclics, heterocyclics such as furans, pyridines, pyrazines and the like, sulfur-containing materials including thiols, sulfides, disulfides and the like, proteins, lipids, carbohydrates, and so-called flavor potentiators such as monosodium glutamate, guanylates, inosinates, natural flavoring materials such as vanillin, and the like. The types and amounts of materials selected from the foregoing groups of materials may depend upon the flavor profile desired in the finished product.

The flavor composition may include carriers such as gum arabic and carrageenan or vehicles such as ethyl alcohol, water, propylene glycol. When the carrier is an emulsion, the flavoring composition may also contain emulsifiers such as mono- and diglycerides of fatty acids and the like. With these carriers or vehicles, the desired physical form of the composition can be prepared. It will be understood that the flavoring compositions can initially be in spray-dried, liquid, encapsulated, emulsified and other forms in which flavorings are added to foodstuffs.

In certain examples, the flavor composition includes a dairy flavor agent.

In certain examples, the flavor composition may include at least one flavoring acid composition. In certain examples, the at least one flavoring acid composition includes lactic acid, malic acid, or a combination thereof. These flavoring acid compositions are advantageous in providing a flavor profile that may not be possible in a conventional coating composition that is not protected within a porous coating (e.g., cracker meal) and coated with an external solidified oil (as described below). For instance, to the extent a flavoring acid such as lactic or malic acid is added to a conventional bread or batter coating composition, the lactic or malic acid may prematurely react with components (e.g., sodium bicarbonate) within the batter coating during a par-cooking, releasing carbon dioxide prematurely and distorting the flavor profile.

In certain examples, the at least one flavor composition may be manufactured through a spray dry technique known in the art. In certain examples, one or more spray drying parameters may be adjusted (e.g., flow rate, nozzle size, drying temperature, air flow rate and direction) to modify or target a specific particle size of an encapsulated flavor agent. In certain examples, the particle sizes of the flavor composition are targeted in a spray drying process such that the average diameter of a encapsulated flavor particle or granule is less than the average diameter of a pore within the porous coating composition. This is advantageous is providing a flavor-porous composition mixture has smaller flavor particle sizes than pore openings, allowing for at least a portion of the flavor composition to be absorbed or fit within the pores of the porous coating composition (therein protecting/preventing the flavor compositions from flashing off).

In act 104, the porous coating composition is mixed with the at least one flavor composition, wherein at least a portion of the at least one flavor composition is absorbed into pores of the porous coating composition. As noted above, this process is advantageous in protecting the flavor composition from prematurely volatizing or evaporating.

The porous coating and flavor compositions may be mixed using any mixing equipment, technique, or time known in the art. For example, a ribbon or dough blender may be used to mix the components together. The amount of mixing time may be based on the time required to form a uniform flavor-porous coating mixture.

In certain examples, a liquid oil (separate from the oil feedstock discussed below) may be added to the solid components as an anti-dusting oil to improve the mixing process and limit or prevent stratification or dusting created by the dry components during the mixing process. Any oil may be used, such as the natural oils discussed in greater detail below. In one particular example, a small amount of soybean oil is used in this mixing process (e.g., less than 5 percent by weight or less than 1 percent by weight of the flavor-porous coating mixture).

In act 106, an oil feedstock is provided. In certain embodiments, the oil feedstock is a natural oil feedstock or a derivative thereof. Examples of natural oils include, but are not limited to, vegetable oils, algae oils, fish oils, animal fats, tall oils, derivatives of these oils, combinations of any of these oils, and the like. Representative non-limiting examples of vegetable oils include canola oil, rapeseed oil, coconut oil, corn oil, cottonseed oil, olive oil, palm oil, peanut oil, safflower oil, sesame oil, soybean oil, sunflower oil, linseed oil, palm kernel oil, tung oil, jatropha oil, mustard oil, pennycress oil, camelina oil, and castor oil. Representative non-limiting examples of animal fats include lard, tallow, poultry fat, yellow grease, and fish oil.

In certain examples, the oil feedstock has a melting point greater than 10° C., 15° C., 20° C., 25° C., 30° C., 35° C., or 40° C. In some examples, the oil feedstock may be solid in ambient temperature conditions (i.e., 20-25° C.). This is advantageous for reasons explained in greater detail below during formulation of the food coating composition, wherein the oil feedstock may form an external coating or shell protecting the flavor compositions contained within.

Certain natural oils, without modification, have such a melting point greater than at least 20° C. For example, the oil feedstock may be a natural oil such as palm oil, palm kernel oil, coconut oil, or combinations thereof. In one particular example, the oil feedstock provided for the food coating composition is palm kernel oil.

In some examples, the oil feedstock may be modified to increase its melting point to a temperature greater than at least 10° C., 15° C., 20° C., 25° C., 30° C., 35° C., or 40° C. For example, an oil feedstock may be at least partially hydrogenated (e.g., fully hydrogenated) to increase the melting point of the oil feedstock above 20° C. or 25° C. Additionally, or alternatively, the oil feedstock may be interesterified to increase the melting point of the oil feedstock.

With regard to hydrogenation, such a treatment may include hydrogenating one or more unsaturated carbon-carbon bonds within the oil feedstock, wherein the at least partially saturated, treated oil feedstock has a higher melting point than the untreated oil feedstock. For example, the treated oil feedstock for use in the food coating composition may be fully hydrogenated canola or soybean oil.

Hydrogenation may be conducted according to any known method in the art for hydrogenating double bond-containing compounds such as the olefins present in the oil feedstock. In certain embodiments, the oil feedstock and hydrogen gas may be feed to a hydrogenation unit, wherein the oil feedstock is reacted with the hydrogen gas in the presence of a hydrogenation catalyst to produce a hydrogenated product comprising partially to fully hydrogenated paraffins/olefins. Any known hydrogenation catalyst and operating condition may be employed to conduct the hydrogenation of the oil feedstock.

In certain examples, the amount of hydrogenation catalyst may be selected in view of a number of factors including, for example, the type of hydrogenation catalyst used, the amount of hydrogenation catalyst used, the degree of unsaturation in the material to be hydrogenated, the desired rate of hydrogenation, the desired degree of hydrogenation, the purity of the reagent, and the H₂ gas pressure.

Regarding interesterifying the oil feedstock, fatty acids may be rearranged on the glycerol backbone of various triglycerides of the oil feedstock. Such a rearrangement of fatty acids may alter (e.g., raise) the melting point of the oil feedstock.

Interesterification may be conducted according to any known method in the art for feedstocks including triglycerides. In certain embodiments, the interesterification may be an enzymatic interesterification, wherein an enzyme (e.g., esterase or acylase) is added to the oil feedstock. In alternative embodiments, the interesterification may be a chemical interesterification, wherein a catalyst (e.g., sodium methoxide) is added to the oil feedstock to produce the interesterified feedstock along with various byproducts such as sodium soaps, fatty methyl esters, and monoglycerides).

In act 108, the oil feedstock (or treated oil feedstock) is heated to the melting point of the oil or to a temperature greater than the melting point of the oil feedstock to form a liquid oil. Any heating technique or equipment known known in the art may be used in this act.

In certain examples, the oil feedstock is heated to the melting point of the oil or at a temperature at least 0.1° C. greater than the melting point of the oil, at least 0.5° C. greater than the melting point, at least 1° C. greater than the melting point, at least 2° C. greater than the melting point, at least 3° C. greater than the melting point, at least 5° C. greater than the melting point, at least 10° C. greater than the melting point, between 0-10° C. above the melting point, between 0.1-5° C. above the melting point, or between 1-5° C. above the melting point of the oil.

In act 110, the heated liquid oil is mixed with the flavor-porous coating mixture to form an oil-flavor-porous coating mixture. This process is advantageous in encapsulating or coating the flavor-porous coating material with the liquid oil, wherein the liquid oil forms an external coating around the flavor-porous coating material. The heated liquid oil and flavor-porous coating mixture may be mixed using any mixing equipment, technique, or time known in the art. For example, a ribbon or dough blender may be used to mix the components together.

In act 112, the oil-flavor-porous coating mixture is cooled to at least ambient room temperature (i.e., to 25° C. or less) to form a food coating composition. The cooling process may begin upon contact of the heated liquid oil with the flavor-porous coating material. In some examples, the oil-flavor-porous coating mixture is cooled to at least 25° C., 20° C., 15° C., or 10° C. In this cooling act, the heated liquid oil cools and solidifies as an exterior coating for the porous coating composition and the at least one flavor composition absorbed within the pores of the porous coating composition. As noted above, this is advantageous in providing a further obstacle for premature volatizing or evaporating of the at least one flavor composition. For example, the solidified oil external coating around the porous coating composition and flavor composition allows for a protective crust to form during the initial stages of cooking a food product having the food coating composition, therein sealing in the flavor composition from flashing off or evaporating during the initial stages of cooking.

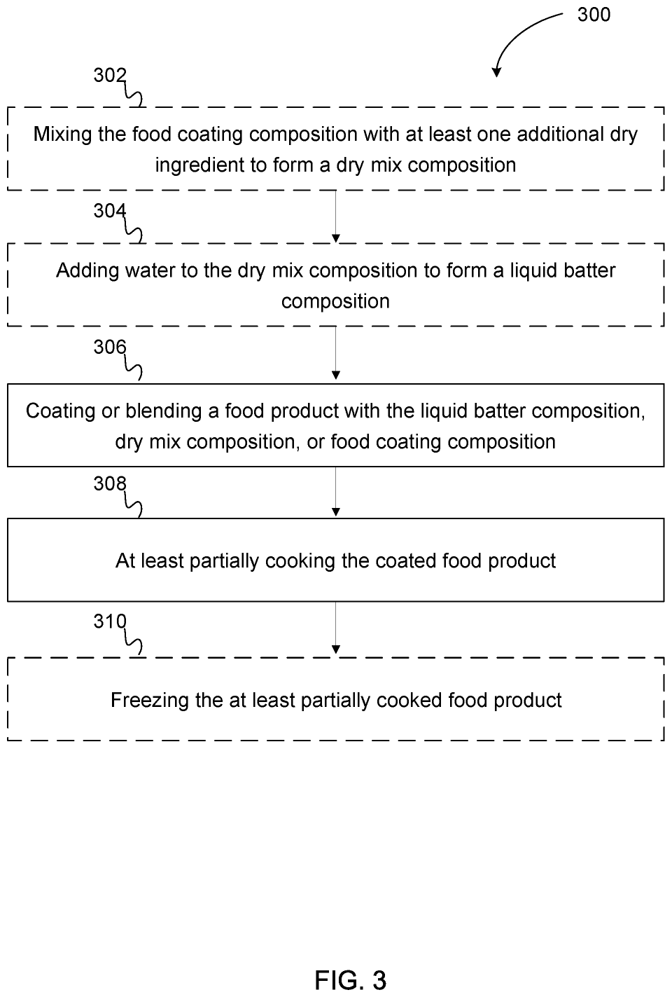

In act 114, the food coating composition is sifted through a screen to remove large granules or clumps that may form during the cooling process. This is advantageous in creating a more uniform particle or granule size mixture, which may allow for a more free-flowing, easier to transfer mixture (therein improving the overall process flow for manufacturing the dry food coating composition). The more uniform particle or granule size mixture may also be advantageous for further downstream processing and mixing (e.g., in the formulation of a dry mix composition or liquid batter composition, as discussed below with reference to FIG. 3). In some examples, the food coating composition is sifted or granulated as it is still cooling to ambient temperature conditions. This may be advantageous in improving the coating process of the oil on the porous material and enhancing the rate at which the food coating composition is cooled.

Any known sifting process and equipment may be used. The type of equipment chosen may be based on the desired particle or granule size of the food coating composition. In certain examples, a hammer mill may be used to shred or crush large granules into smaller pieces. The material may be sifted through a screen in the drum of the hammer mill. In certain examples, the screen size may be in a range of 5-30 mesh, 10-25 mesh, or 12-20 mesh.

In certain embodiments, the cooling and sifting in acts 112 and 114 are performed within a certain time frame following the mixing of the oil with the porous coating and flavor agents. For example, the processes may take place within a time frame of 1-12 hours, 1-6 hours, or 1-3 hours from the time of mixing. This is advantageous in preventing the external coat of oil from separating from the underlying porous coating and flavor compositions.

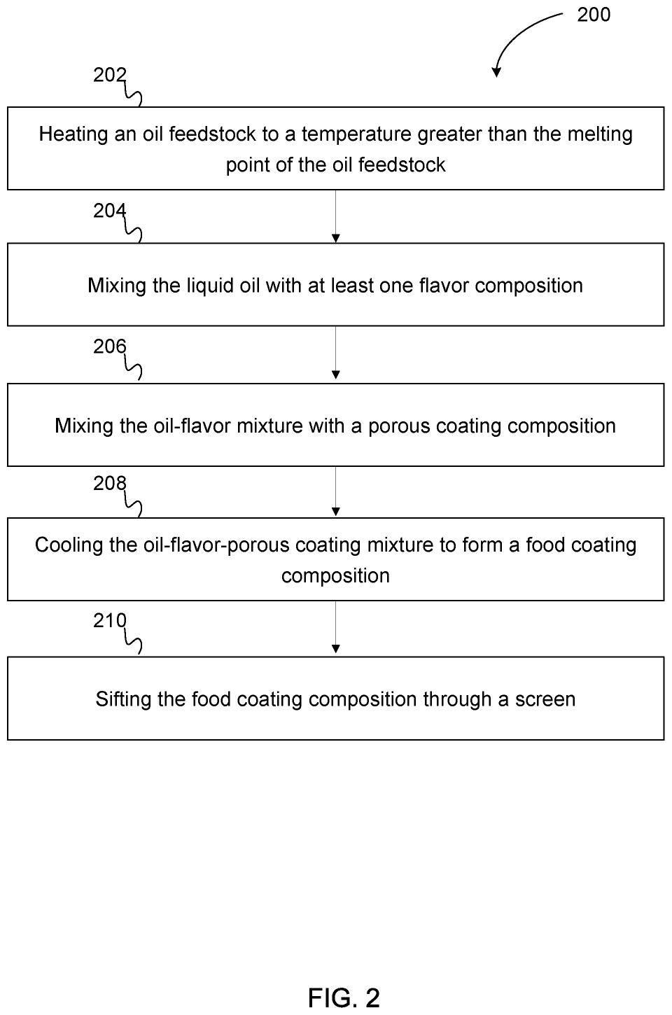

FIG. 2 illustrates an additional example flowchart for making a food coating composition. In this example, similar compositions or feedstocks are used to form the food coating composition, but the order of addition has been rearranged (e.g., the liquid oil feedstock is mixed with the flavor composition prior to or concurrent with mixing with the porous coating composition). Additional, fewer, or different acts may be included within the method of making.

As depicted in FIG. 2, in act 202, the oil feedstock is heated to a temperature greater than the melting point of the oil feedstock to form a liquid oil. The parameters for heating the oil feedstock are similar to those discussed above for the example in FIG. 1.

In act 204, the heated liquid oil feedstock is mixed with at least one flavor agent or composition to provide an oil-flavor mixture.

In act 206, the oil-flavor mixture is mixed with the porous coating composition to provide an oil-flavor-porous coating mixture. In this act, at least a portion of the flavor composition within the oil may be absorbed or embedded within the pores of the porous coating composition.

In act 208, the oil-flavor-porous coating mixture is cooled to at least ambient room temperature (i.e., to 25° C. or less) to form the food coating composition. As noted above, when the liquid oil cools, it may solidify as an exterior coating for the porous coating composition and the at least one flavor composition absorbed within the pores of the porous coating composition, therein providing a protective barrier for the flavor composition.

In act 210, the cooled, solidified food coating composition is sifted through a screen to remove large granules or clumps that formed during the cooling process.

The food coating composition, as disclosed in the examples with FIGS. 1 and 2, may then be used in the formation of a liquid batter composition for food products, as discussed below.

In certain embodiments, the food coating composition prepared via the acts described above may be used to form a liquid batter composition for providing an external coating of a food product. Alternatively, the food coating composition may be used to form a dry mix material for providing an external coating of a food product, or an internal component for a blended food product (such as a veggie burger or ‘meatless’ meat patty). In other examples, the food coating composition may be used by itself (e.g., without forming a liquid batter or a dry mix material) to provide the external coating of the food product or the internal component of the blended food product. Such coated or blended food products having the food coating composition, dry mix composition, or batter composition may be cooked by any known method (e.g., frying or baking).

FIG. 3 illustrates an example flowchart for preparing and using a batter composition with the food coating composition or, alternatively, using the food coating composition or a dry mix composition having the food coating composition with a food product. Additional, fewer, or different acts may be included within the method of making.

In act 302, the food coating composition may be mixed with at least one additional dry ingredient to form a dry mix composition. The at least one additional dry ingredient may include flour (e.g., wheat and/or white flour), corn meal, sugar, dextrose, salt, baking powder, or a combination thereof. The mixing process may also include the addition of a liquid oil as an anti-dusting oil to improve the mixing process and limit or prevent stratification or dusting created by the dry mixture components during the mixing process. Any oil may be used, such as the natural oils discussed in greater detail above. In one particular example, a small amount of soybean oil is used in this mixing process (e.g., less than 5 percent by weight or less than 1 percent by weight of the dry mix).

The amount or ratio of food coating composition to additional dry mix ingredients may be adjustable. In certain examples, the weight ratio of food coating composition to additional dry ingredients is in a range between 1:99 and 99:1 (i.e., between 1 weight percent food coating composition and 99 weight percent additional dry ingredients to 99 weight percent food coating composition and 1 weight percent additional dry ingredients), between 5:95 and 30:70, between 10:20 and 20:80, or approximately 15:85.

To the extent a liquid oil is added to the overall dry mix composition, the amount of oil within the dry mix composition may be in a range of 0.1-10 percent by weight oil or in a range of 1-5 percent by weight oil. Any oil may be used, such as the natural oils discussed in greater detail above.

In act 304, water may be added to the dry mix composition to form a liquid batter composition. The amount or ratio of dry mix to liquid may be adjustable. In certain examples, the weight ratio of dry mix to liquid is in a range between 10:90 and 90:10 (i.e., between 10 weight percent dry mix and 90 weight percent water to 90 weight percent dry mix and 10 weight percent water), between 20:80 and 80:20, between 30:70 and 70:30, between 40:60 and 60:40, or between 45:55 and 55:45 dry mix:water.

In act 306, a food product may be at least partially coated or mixed with the liquid batter composition, dry mix composition, or food coating composition. The coating process may take place by dipping at least a portion of the food product into the liquid batter, by brushing the liquid batter coating on a surface of the food product, or by spraying a surface of food product with the liquid batter.

Alternatively, the food product may be at least partially coated or blended with the dry mix composition or food coating composition (i.e., acts 302 and/or 304 are skipped). This process may include dusting a surface of the food product with the dry mix or food coating composition. Alternatively, the process may include pressing a surface of the food product into a dry mix or food coating composition to adhere or embed a surface of the food product with the dry material. In some examples, the food product is wetted or dipped in a liquid (e.g., water or egg batter) prior to applying the food coating composition or dry mix composition to assist in adhering the dry composition to the food product.

In other examples, the process may include blending or mixing the food coating or dry mix composition with the food product (such as a meatless, vegetable patty for grilling).

Any type of food product may be used in this process. In particular, meat or fish products may be used. Such food products include chicken (e.g., breasts, wings, strips, nuggets), steak, pork cutlets, hot dogs, cod, catfish, tilapia, shrimp, and so on. Alternatively, as noted above, vegetable food products may be used. For example, a vegetable (veggie) burger may be formulated with the food coating/dry mix composition or the liquid batter composition, wherein the surface of the veggie burger is coated or the contents of the veggie burger are blended with the food coating/dry mix composition or liquid batter.

In act 308, the coated food product may be at least partially-cooked (i.e., par-cooked) to adhere the liquid batter composition, dry mix composition, or food coating composition to the surface of the food product or to at least partially cook the blended food product having the food coating or dry mix composition. Par-cooking refers to the technique of partially cooking foods so that they can be finished later. This may be using frying oil, baking the food product, or any other known cooking method. This par-cooking process may be advantageous in allowing foods to be prepared ahead of time, and quickly heated prior to serving. Additionally, the second reheat finishes the cooking process, so foods are not overcooked as leftovers often are. This is a common technique in the processed food industry, and most frozen and prepared foods are par-cooked. This par-cooking process may also advantageous in heating the liquid batter, dry mix or food coating composition to create a protective crust or seal around the food product, protecting the at least one flavor composition within the food coating composition from being evaporated or flashed off. To the extent the method involves par-frying or partially cooking the food product in frying oil, the food coating composition may be advantageous in reducing the amount of contamination of the frying oil, as less flavor compositions are being released or flashed off in the frying oil (as compared to a coating composition without the sealed-in flavor disclosed herein). This may allow for a reduction in cost, as less frying oil may be required due to lower contamination.

In some examples, the coated or blended food product is fully-cooked in act 308. This may involve using frying oil, baking the food product, or any other known cooking method.

In act 310, the at least partially-cooked food product may be frozen or stored for future use (i.e., fully cooking, reheating, and consuming the food product). The cooking process may be conducted using an oven, stove-top, or microwave, for example.

### EXAMPLES

### Example 1. Formation of Food Coating Composition

8.21 kg cracker meal (breader predust), 1.08 kg lactic acid, 0.35 kg malic acid, and 1.08 kg additional flavor agents (spray dried cheese and/or dairy flavor agents) are mixed together. 4.6 kg palm kernel oil is heated above its melting point temperature to form a liquid oil composition. The mixture of cracker meal, flavor acids, and additional flavors is added to the heated oil and mixed until uniform. After the mixture is uniform, the oil-flavor-cracker meal mixture is cooled to ambient temperature (20-25° C.) conditions, and allowed to rest at ambient temperature for 1-2 hours, wherein the palm kernel oil solidifies and forms an exterior coating for the food coating composition.

The cooled coating composition is then sifted to through a 12-20 mesh sifter to remove any large granules and form a more uniform particle/granule size composition.

### Example 2. Formation of Batter Composition

The cooled, sifted food coating composition from Example 1 is mixed with 20.0 kg flour (bread, white, enriched), 21.5 kg corn meal (yellow, degerminated, enriched), 10.0 kg yellow corn flour (Bob's Red Mill Whole Grain), 5.4 kg sugar (Bakers, 4× Cake), 2.2 kg dextrose, 2.2 kg salt (flour), 0.65 kg baking powder (double acting, Clabber girl), 1.2 kg colorant (processed cheese color) to provide a partial dry mixture composition. This partial dry mixture composition is blended with 3.1 kg soybean oil (salad or cooking oil) to minimize dust. Additionally, 12.0 kg of flour (wheat, all purpose) is added to provide a dry mix composition.

The dry mix composition is mixed with water (55 parts by weight dry mix to 45 parts by weight water) until a thick liquid batter composition.

### Example 3. Use of Batter Composition with Food Product

A food product is dipped into the liquid batter (twice) to coat the exterior of the food product. The coated food product is then par-fried for 2.5 minutes at 190° C. (375° F.), wherein the liquid batter on the surface of the food product is partially cooked to form a protective crust for the food product.

The partially cooked food product is then frozen for later cooking and consumption.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

1. A method of making a food coating composition comprising:
providing a porous coating composition, at least one flavor composition, and an oil feedstock having a melting point greater than 20° C.;
mixing the porous coating composition with the at least one flavor composition, wherein at least a portion of the at least one flavor composition is absorbed into pores of the porous coating composition;
heating the oil feedstock to a temperature greater than the melting point of the oil feedstock to form a liquid oil;
mixing the liquid oil with the at least one flavor composition prior to, contemporaneous with, or after the at least one flavor composition is mixed with the porous coating composition to provide an oil-flavor-porous coating mixture; and
cooling the oil-flavor-porous coating mixture to 25° C. or less to form a food coating composition having a plurality of granules, wherein the liquid oil solidifies as an exterior coating for the porous coating composition and the flavor composition absorbed within the pores of the porous coating composition,
wherein the cooling of the oil-flavor-porous coating mixture is conducted prior to an optional application of the food coating composition to a food product.

2. The method of claim 1, wherein the liquid oil is mixed with the at least one flavor composition after the at least one flavor composition is mixed with the porous coating composition.

3. The method of claim 1, wherein the liquid oil is mixed with the at least one flavor composition before the at least one flavor composition is mixed with the porous coating composition.

4. The method of claim 1, wherein the oil feedstock is selected from the group consisting of palm oil, palm kernel oil, coconut oil, or combinations thereof.

5. The method of claim 1, further comprising:
at least partially hydrogenating or interesterifying the oil feedstock to increase the melting point of the oil feedstock above 20° C.

6. The method of claim 1, wherein the porous coating composition comprises cracker meal, bread crumbs, a textured protein, or a combination thereof.

7. The method of claim 1, further comprising:
sifting the food coating composition through a screen to adjust a range of particle sizes of the food coating composition.

8. The method of claim 1, wherein the at least one flavor composition comprises at least one acid composition selected from the group consisting of lactic acid, malic acid, and combinations thereof.

9. The method of claim 1, further comprising:
mixing the food coating composition with at least one additional dry ingredient to form a dry mix composition.

10. The method of claim 9, wherein the at least one additional dry ingredient comprises flour, corn meal, sugar, dextrose, salt, baking powder, or a combination thereof.

11. The method of claim 9, further comprising:
blending the dry mix composition with another food composition to form a meatless food patty.

12. The method of claim 9, further comprising:
adding water to the dry mix composition to form a liquid batter composition;
coating the food product with the liquid batter composition;
par-cooking the coated food product, wherein the at least one flavor composition within the pores of the porous coating composition is retained within the coated food product; and
freezing the par-cooked food product.

13. The method of claim 1, further comprising:
blending the food coating composition with another food composition to form a meatless food patty.

14. The method of claim 1, wherein the food coating composition comprises:
30-80 percent by weight of the porous coating composition selected from the group consisting of cracker meal, bread crumbs, a textured protein, or a combination thereof;
0.1-20 percent by weight of the at least one flavor composition; and
10-50 percent by weight of the oil feedstock.

15. The method of claim 1, wherein the food coating composition comprises:
50-60 percent by weight of the porous coating composition selected from the group consisting of cracker meal, bread crumbs, a textured protein, or a combination thereof;
5-20 percent by weight of the at least one flavor composition; and
25-35 percent by weight of the oil feedstock.

16.-20. (canceled)

21. The method of claim 1, wherein particle sizes for each flavor composition of the at least one flavor composition has an average diameter, and
wherein the average diameter for each flavor composition is less than an average diameter of the pores in the porous food composition.

22. The method of claim 1, wherein, in the cooling, the oil-flavor-porous coating mixture is cooled to a temperature in a range of 10° C.-25° C.

23. The method of claim 1, wherein, in the cooling, the liquid oil solidifies as an exterior coating at a temperature in a range of 10-25° C.

24. The method of claim 1, wherein the solidified oil external coating around the porous coating composition and flavor composition is configured to seal in the flavor composition from flashing off or evaporating during initial stages of cooking.
